(19) United States
(12) Patent Application Publication
(10) Pub. No.: US 2014/0131987 A1
(43) Pub. Date: May 15, 2014

(54) DOUBLE-SIDED PRINTING AND BINDING OF BOOK HARDCOVERS

(71) Applicant: Clifford Kevin Royle, Patterson Lakes (AU)

(72) Inventor: Clifford Kevin Royle, Patterson Lakes (AU)

(73) Assignee: ROYALBIND PTY LTD, Carrum Downs (AU)

(21) Appl. No.: 14/111,082

(22) PCT Filed: Apr. 11, 2012
(86) PCT No.: PCT/IB2012/000722

§ 371 Date: Jan. 14, 2014

(30) Foreign Application Priority Data
Apr. 11, 2011 (AU) 2011901316
Aug. 15, 2011 (AU) 2011903243

(51) Int. Cl. B42C 7/00; B42D 3/02

(52) U.S. Cl. CPC B42C 7/006; B42D 3/02
USPC 281/29; 412/3; 412/17

(57) ABSTRACT

A process for double-sided printing of a book hardcover, which includes: providing a book hardcover having a spine between front and back covers all integrally formed from a single blank of foldable board material, wherein the front and back covers each have polymer coated inside and outside surfaces; providing inside and outside dye sublimation sheets respectively printed with inside and outside front and back cover images using dye sublimation ink; superposing the inside and outside dye sublimation sheets respectively on the inside and outside surfaces of the front and back covers when the book hardcover is open flat; applying heat and pressure to the superposed inside and outside dye sublimation sheets and inside and outside surfaces of the front and back covers to respectively sublimate the dye sublimation ink of the inside and outside front and back cover images into the polymer coatings on the inside and outside surfaces of the front and back covers to thereby form a double-sided printed book hardcover.

### FIELD

The present invention relates to double-sided printing and binding of book hardcovers.

### BACKGROUND

The present applicant's WO 2006/092027, which is hereby incorporated in its entirety, describes book hardcovers having a spine between front and back covers all integrally formed from a single blank of foldable board material.

A need exists for simple and effective means for double-sided printing and binding the book hardcovers of WO 2006/092027 to form hardcover books, for example, personalised photo or event books.

### SUMMARY

According to the present invention, there is provided a process for double-sided printing of a book hardcover, which includes:

providing a book hardcover having a spine between front and back covers all integrally formed from a single blank of foldable board material, wherein the front and back covers each have polymer coated inside and outside surfaces;

providing inside and outside dye sublimation sheets respectively printed with inside and outside front and back cover images using dye sublimation ink;

superposing the inside and outside dye sublimation sheets respectively on the inside and outside surfaces of the front and back covers when the book hardcover is open flat;

applying heat and pressure to the superposed inside and outside dye sublimation sheets and inside and outside surfaces of the front and back covers to respectively sublimate the dye sublimation ink of the inside and outside front and back cover images into the polymer coatings on the inside and outside surfaces of the front and back covers to thereby form a double-sided printed book hardcover.

The present invention also provides a double-sided heat press for use in the above process, wherein the double-sided heat press has upper and lower heating platens with respective upper and lower non-stick covers are adapted to automatically separate the double-sided printed book hardcover from the upper and lower heating platens when the double-sided heat press is opened.

The present invention further provides a bookbinding strip for binding book pages to a double-sided printed book hardcover formed by the above process, wherein the bookbinding strip has mutually parallel longitudinal fold lines defining a first pair of flaps hinged to opposite sides of a central panel, a second pair of flaps hinged to opposite sides of the first pair of flaps, and a third pair of flaps hinged to opposite sides of the second pair of flaps, wherein the central panel and the first pair of flaps are foldable into a square U-shape to receive the book pages, and wherein the third pair of flaps are receivable in a pair of slots formed in the front and back covers on opposite sides of the spine.

The present invention also provides a hardcover book including a double-sided printed book hardcover formed by the above process, and book pages bound thereto by the above bookbinding strip.

### BRIEF DESCRIPTION OF DRAWINGS

Embodiments of the invention will now be described by way of example only with reference to the accompanying drawing, in which:

FIG. 1 illustrates sequential folding and gluing steps to form a book hardcover for use in a double-sided printing process according to one embodiment of the present invention;

FIG. 2 is a perspective view of a double-sided heat press for double-sided printing of the book hardcover;

FIG. 3 is a perspective top view of a bookbinding strip for binding book pages to the double-sided printed book hardcover;

FIG. 4 is a perspective end view of book pages bound to the bookbinding strip;

FIG. 5 is a side view of the bookbinding strip and bound book pages being inserted into the double-sided printed book hardcover; and

FIG. 6 is a perspective view of a hardcover book having book pages bound to the double-sided printed hardcover by the bookbinding strip.

### DETAILED DESCRIPTION

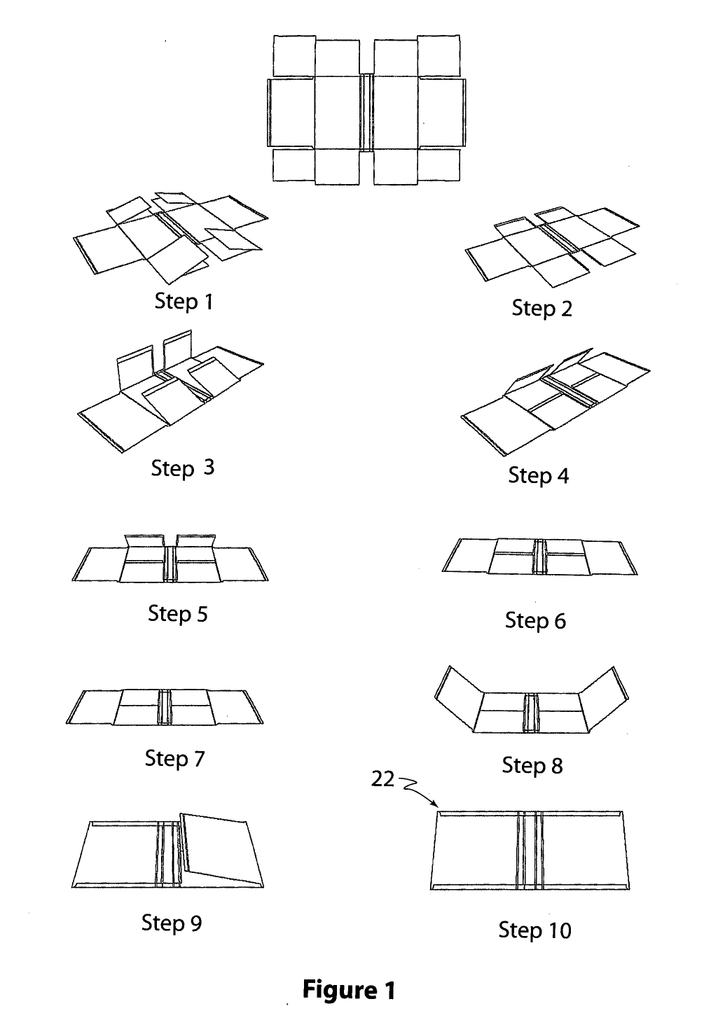

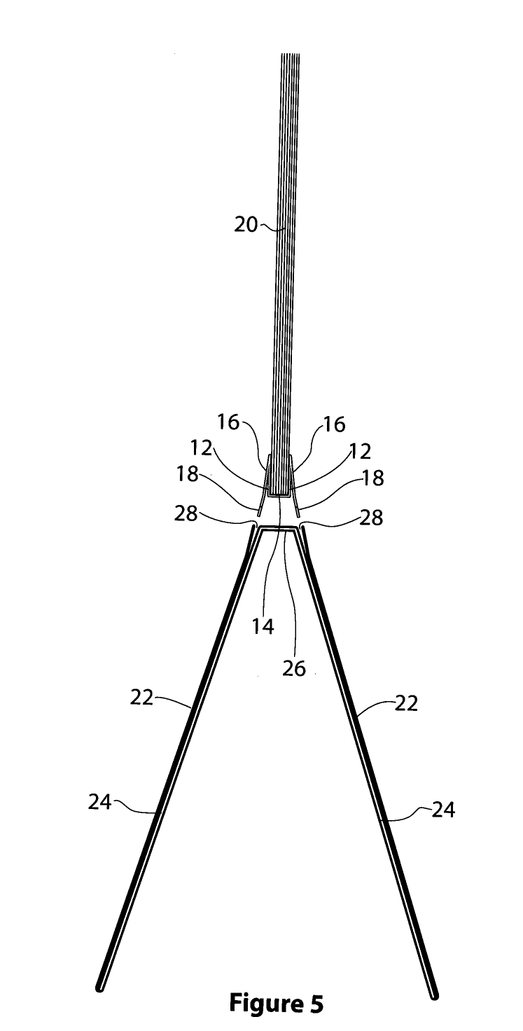

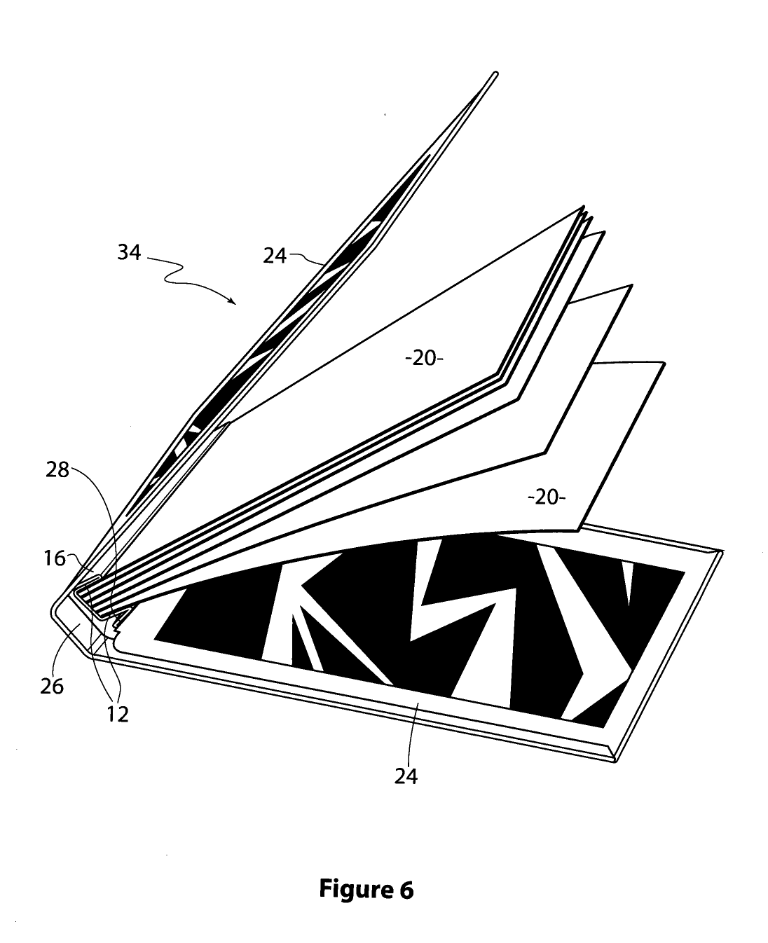

The process for double-sided printing of a book hardcover of the present invention starts by providing a book hardcover 22 described in WO 2006/092027. The book hardcover 22 is formed by the sequential folding and gluing steps illustrated in FIG. 1. Referring to FIGS. 4 and 5, the resulting book hardcover 22 includes a spine 26 between front and back covers 24 all integrally formed from a single blank of foldable board material, for example paperboard coated on one side with a polymer such as polyester. The front and back covers 24 are each integrally formed into a solid and rigid panel from four layers of the blank that are folded over each other, and glued to each other using thermal glue. The four layers of each of the front and back covers 24 are formed from a central section with opposing elongate flaps each hinged to the central section on opposite sides of the central section along first fold lines that are at only a part of one side of the elongate flaps, each elongate flap being folded onto itself for forming a smaller two layered flap that is folded over the central section, and a large flap foldably connected to another side of the central section along a second fold line and folded over the elongate flaps and the central section. A pair of slots 28 are formed on opposite sides of the spine 26 of the hardcover 22 between outermost and innermost layers of the four folded overlapping layers of the front and rear covers 24. After folding and gluing, the front and back covers 24 of the hardcover 22 each have polymer coated inside and outside surfaces, and the spine 26 has a polymer coated outside surface. The hardcover 22 is optionally heat conditioned to remove residual moisture from the paperboard and/or glue before dye sublimation printing.

Next the double-sided printing process of the invention includes providing inside and outside dye sublimation sheets 30, 32 respectively printed with inside and outside front and back cover images using dye sublimation ink. The outside dye sublimation sheet 30 optionally also includes an outside spine image. The inside and outside front and back cover images, and outside spine image, are selected using photo book software online or in a retail photo book kiosk. The dye sublimation sheets 30, 32 are, for example, sheets of dye sublimation paper printed with images using, for example, an inkjet printer supplied with dye sublimation inks.

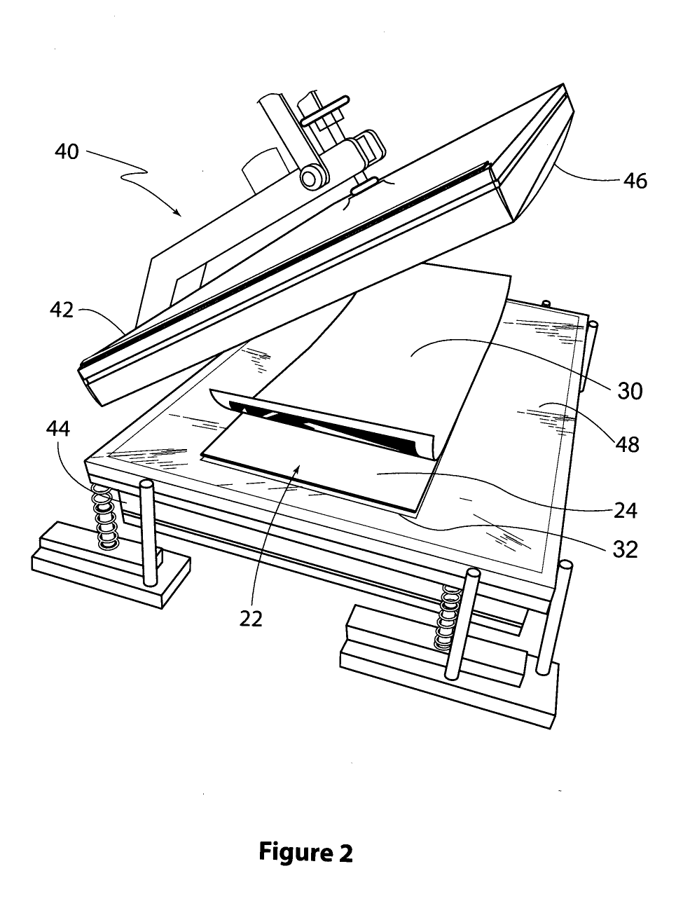

Referring to FIG. 2, the process moves to superposing the inside and outside dye sublimation sheets 30, 32 respectively on the inside and outside surfaces of the front and back covers 24 when the book hardcover 22 is open flat. The dye sublimation sheets 30, 32 are positioned and superposed over the inside and outside front surfaces of the front and back covers 24 using an inclined or horizontal planar guide or jig (not shown). To provide a smooth inside surface of the flat hardcover 22, a blank of paperboard (not shown) is placed in the recess formed by the single layer inside surface of the spine 26 between the four layers of the front and back covers 24. The dye sublimation sheets 30, 32 are taped in place at the spine 26 using heat resistant tape (not shown).

Heat and pressure are then applied to the superposed inside and outside dye sublimation sheets 30, 32 and inside and outside surfaces of the front and back covers 24 using a double-sided heat press 40 as illustrated in FIG. 2 (for clarity the lift handle has been partially omitted). The double-sided heat press 40 is, for example, a clamshell-type double-sided heat press having an upper heating platen 42 that is pivotally openable and closable over a stationary lower heating platen 44. Other equivalent double-sided heat presses, such as vertical heat presses, may also be used. In use, the double-sided heat press 40 applies sufficient heat and pressure for a predetermined time to the superposed inside and outside dye sublimation sheets 30, 32 and inside and outside surfaces of the front and back covers 24 to respectively sublimate the dye sublimation ink of the inside and outside front and back cover images into the polymer coatings on the inside and outside surfaces of the front and back covers 24 to thereby form a double-sided printed book hardcover 22. An outside spine image is also optionally transferred by dye sublimation printing to the outside surface of the spine 26. The heat applied during the dye sublimation printing advantageously completes the heat curing of the thermal glue used to form the hardcover 22 as described above.

The upper and lower heating platens 42, 44 have respective upper and lower non-stick covers 46, 48 that are adapted to automatically and evenly separate the double-sided printed book hardcover 22 from the upper and lower heating platens 42, 44 when the double-sided heat press 40 is opened after the required temperature, pressure and time for dye sublimation has been reached. The upper and lower non-stick covers 46, 48 prevent the inside and outside surfaces of the front and back covers from being vacuum (or vapour) locked to the upper and lower heating platens 42, 44 due to vaporisation of the dye sublimation ink and/or moisture in the hardcover 22. This prevents degradation of the quality and resolution of the dye sublimation printed images due to over-sublimation or vaporisation of the dye sublimation ink. The upper non-stick cover 46 is, for example, a flexible, non-stick sheet slackly hung below the upper heating platen, and the lower non-stick cover 48 is, for example, a non-stick screen having a peripheral frame that is spring loaded above the lower heating platen 44 by springs mounted on guide posts around the periphery of the lower heating platen 44. Other equivalent resilient biasing or spring loading arrangements may also be used to bias the lower non-stick cover 48 away from the lower heating platen 44. The upper non-stick sheet 46 and the lower non-stick screen 48 are, for example, Teflon (polytetrafluoroethylene) sheets.

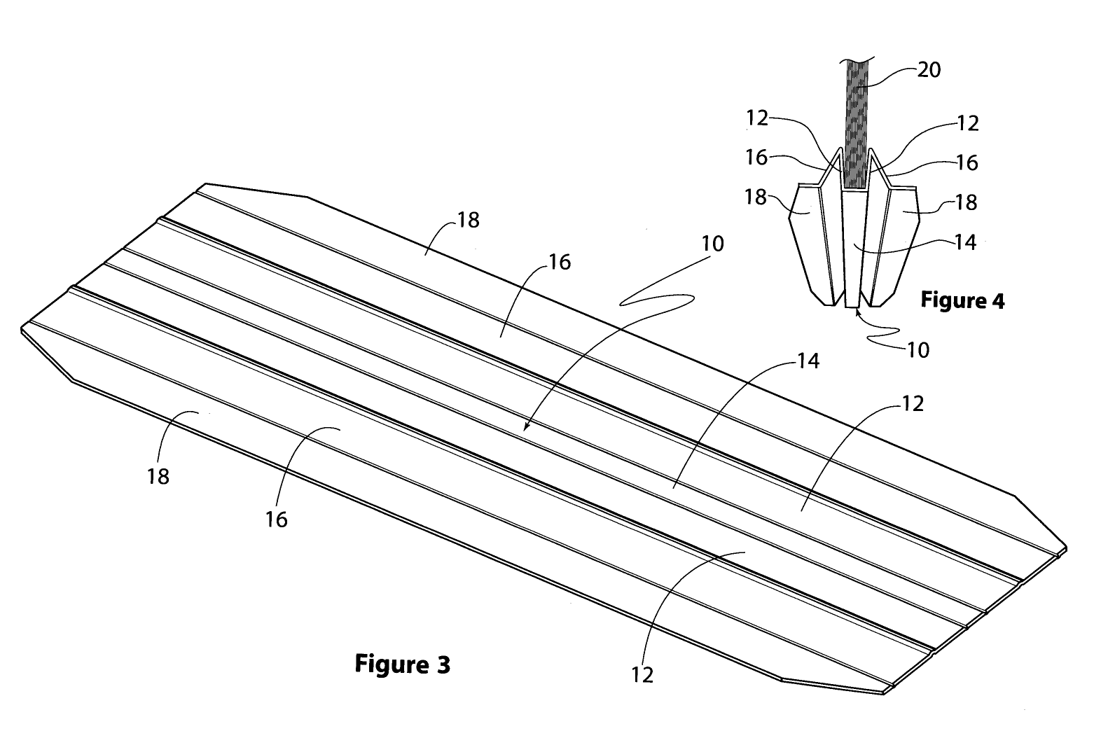

FIG. 3 illustrates a bookbinding strip 10 according to an embodiment of the present invention for binding book pages 20 to the double-sided printed book hardcover 22 formed by the process described above. The bookbinding strip 10 has mutually parallel longitudinal fold lines defining a first pair of flaps 12 hinged to opposite sides of a central panel 14. A second pair of flaps 16 are hinged to opposite sides of the first pair of flaps 12, and a third pair of flaps 18 are hinged to opposite sides of the second pair of flaps 16. The third pair of flaps 18 has tapered (or angled or bevelled) outer corners to aid insertion into the slots 28 of the hardcover 22. The bookbinding strip 10 is, for example, made from paperboard optionally reinforced by coating on one side with a polymer such as polyester. In use, the polymer coated side of the bookbinding strip 10 is arranged to be the externally visible inside facing surface of the second pair of flaps 16 to give a good quality appearance and finish. The bookbinding strip 10 is, for example, formed in a cover creaser.

Referring to FIG. 4, the central panel 14 and the first pair of flaps 12 of the bookbinding strip 10 are folded into a square U-shape to receive printed book pages 20, for example pages of personalised photos. The book pages 20 are bound to the first pair of flaps 12, for example, by fasteners (not shown), such as staples. Further alternatively, the side end edges of the book pages 20 are glued to the first pair of flaps 12, and the end edges of the book pages 20 are glued to the central panel 14, by, for example, thermal glue (or heat activated adhesive). The second and third pairs of flaps 16, 18 are left freely hinged from the bound book pages 20. Strips of thermal glue are also placed on the third pair of flaps 18 to bind the bookbinding strip 10 and the bound book pages 20 to the double-sided printed book hardcover 22 book cover as described below.

FIG. 5 illustrates the bookbinding strip 10 and bound book pages 20 being inserted into the double-sided printed book hardcover 22. The hardcover 22 is opened with the front and back covers 24 bent back over themselves to expose the single layer inside surface of the spine 26 and open the pair of slots 28 formed in the front and back covers 24 along the spine 26. The front and back covers 24 are bent back over themselves, for example, by placing the spine 26 on a horizontal edge of a vertical planar guide or jig (not shown). The pair of slots 28 is opened using, for example, a pair of slot wedges (not shown). The third pair of flaps 18 of the bookbinding strip 10 is then inserted into the pair of slots 28 of the hardcover 22. The third pair of flaps 18 is adhered inside the pair of slots 28 by heating the thermal glue strips previously provided on the third pair of flaps 18. This is performed, for example, by placing the spine 26 and spine-end portions of the front and back covers 24 flat between the upper and lower heating platens 42, 44 of the double-sided heat transfer press 40.

The double-sided printed hardcover 22 and the bookbinding strip 10 combine to produce a perfect bound hardcover book 34, for example a personalised photo or event book, illustrated in FIG. 6. The hinged articulation between the second and third pairs of flaps 16, 18 of the bookbinding strip 10 allows dynamic natural opening and closing motion of the book 34 by absorbing flexion and extension of the book pages 20 relative to the hardcover 22. This enables easy opening of the photo book 34, and allows every page of the photo book 34 to lay flat when open. The resulting hardcover book 34 is high quality and uniquely has high resolution, vivid colour images printed on both the inside and outside of the front and back covers 24. The bookbinding strip 10 ensures the book pages 20 are permanently bound to the hardcover 22, and the hinged flaps 16, 18 give the book 34 good lay flat properties.

The embodiments and examples of the invention described above provide simple and effective means for double-sided printing and binding the book hardcovers of WO 2006/092027 to form hardcover books, for example, personalised photo or event books. The double-sided printing and binding process of embodiments of the invention provides a simple, low cost ‘turnkey solution’ for photo and event book vendors that enable them to offer double-sided printed hardcover books. The ease, speed and small footprint of the double-sided printing and binding process of the present invention allows professional, high quality hardcover personalised photo or event books to be quickly and easily produced on site in retail settings, such as one-hour photo kiosks or stores. The double-sided printing and binding process of the invention can be performed in a small retail footprint using two desktop machines, i.e. an inkjet printer and the double-sided heat press described above. The availability of quick, high quality retail production of photo books removes disadvantageous aspects of online photo book purchasing, such as long delivery time, difficulty using online photo book software, and concerns about payment security. Currently, in-store, on demand retail photo or event book solutions are inferior in quality and the production process is a difficult, expensive and cumbersome process. Further alternatively, the double-sided printing and binding process of the present invention is scalable for mass-production of photo books by large industrial printers and photo book manufacturers.

The above examples and embodiments have been described by way of example only and modifications are possible within the scope of the claims that follow.

1. A process for double-sided printing of a book hardcover, which includes:
providing a book hardcover having a spine between front and back covers all integrally formed from a single blank of foldable board material, wherein the front and back covers each have polymer coated inside and outside surfaces;
providing inside and outside dye sublimation sheets respectively printed with inside and outside front and back cover images using dye sublimation ink;
superposing the inside and outside dye sublimation sheets respectively on the inside and outside surfaces of the front and back covers when the book hardcover is open flat;
applying heat and pressure to the superposed inside and outside dye sublimation sheets and inside and outside surfaces of the front and back covers to respectively sublimate the dye sublimation ink of the inside and outside front and back cover images into the polymer coatings on the inside and outside surfaces of the front and back covers to thereby form a double-sided printed book hardcover.

2. A process according to claim 1, wherein the front and back covers are each integrally formed into a solid and rigid panel from four layers of the blank that are folded over, and glued to, each other.

3. A double-sided heat press for use in the process of claim 1, wherein the double-sided heat press has upper and lower heating platens with respective upper and lower non-stick covers are adapted to automatically separate the double-sided printed book hardcover from the upper and lower heating platens when the double-sided heat press is opened.

4. A double-sided heat press according to claim 3, wherein the upper non-stick cover is a flexible, non-stick sheet hung below the upper heating platen.

5. A double-sided heat press according to claim 3, wherein the lower non-stick cover is a non-stick screen resiliently biased away from above the lower heating platen.

6. A bookbinding strip for binding book pages to a double-sided printed book hardcover formed by a process according to claim 1, wherein the bookbinding strip has mutually parallel longitudinal fold lines defining a first pair of flaps hinged to opposite sides of a central panel, a second pair of flaps hinged to opposite sides of the first pair of flaps, and a third pair of flaps hinged to opposite sides of the second pair of flaps, wherein the central panel and the first pair of flaps are foldable into a square U-shape to receive the book pages, and wherein the third pair of flaps are receivable in a pair of slots formed in the front and back covers on opposite sides of the spine.

7. A hardcover book including a double-sided printed book hardcover formed by a process according to claim 1, and book pages bound thereto by a bookbinding strip, wherein the bookbinding strip has mutually parallel longitudinal fold lines defining a first pair of flaps hinged to opposite sides of a central panel, a second pair of flaps hinged to opposite sides of the first pair of flaps, and a third pair of flaps hinged to opposite sides of the second pair of flaps, wherein the central panel and the first pair of flaps are foldable into a square U-shape to receive the book pages, and wherein the third pair of flaps are receivable in a pair of slots formed in the front and back covers on opposite sides of the spine.

8. A hardcover book according to claim 7, wherein the hardcover book is a personalised photo or event book.

9. A double-sided heat press for use in the process of claim 2, wherein the double-sided heat press has upper and lower heating platens with respective upper and lower non-stick covers are adapted to automatically separate the double-sided printed book hardcover from the upper and lower heating platens when the double-sided heat press is opened.

10. A double-sided heat press according to claim 9, wherein the upper non-stick cover is a flexible, non-stick sheet hung below the upper heating platen.

11. A double-sided heat press according to claim 10, wherein the lower non-stick cover is a non-stick screen resiliently biased away from above the lower heating platen.

12. A double-sided heat press according to claim 9, wherein the lower non-stick cover is a non-stick screen resiliently biased away from above the lower heating platen.

13. A double-sided heat press according to claim 4, wherein the lower non-stick cover is a non-stick screen resiliently biased away from above the lower heating platen.

14. A bookbinding strip for binding book pages to a double-sided printed book hardcover formed by a process according to claim 2, wherein the bookbinding strip has mutually parallel longitudinal fold lines defining a first pair of flaps hinged to opposite sides of a central panel, a second pair of flaps hinged to opposite sides of the first pair of flaps, and a third pair of flaps hinged to opposite sides of the second pair of flaps, wherein the central panel and the first pair of flaps are foldable into a square U-shape to receive the book pages, and wherein the third pair of flaps are receivable in a pair of slots formed in the front and back covers on opposite sides of the spine.

15. A hardcover book including a double-sided printed book hardcover formed by a process according to claim 2, and book pages bound thereto by a bookbinding strip, wherein the bookbinding strip has mutually parallel longitudinal fold lines defining a first pair of flaps hinged to opposite sides of a central panel, a second pair of flaps hinged to opposite sides of the first pair of flaps, and a third pair of flaps hinged to opposite sides of the second pair of flaps, wherein the central panel and the first pair of flaps are foldable into a square U-shape to receive the book pages, and wherein the third pair of flaps are receivable in a pair of slots formed in the front and back covers on opposite sides of the spine.

16. A hardcover book according to claim 15, wherein the hardcover book is a personalised photo or event book.
